(19) United States
(12) Patent Application Publication
(10) Pub. No.: US 2017/0358101 A1
(43) Pub. Date: Dec. 14, 2017

(54) Optical Image Stabilization for Depth Sensing

(71) Applicant: Apple Inc., Cupertino, CA (US)

(72) Inventors: Thomas E. Bishop, San Francisco, CA (US); Benjamin A. Darling, Cupertino, CA (US); Kevin A. Gross, San Francisco, CA (US); Marius Tico, Mountain View, CA (US); Paul M. Hubel, Mountain View, CA (US); Todd S. Sachs, Palo Alto, CA (US)

(21) Appl. No.: 15/618,641

(22) Filed: Jun. 9, 2017

Related U.S. Application Data
(60) Provisional application No. 62/348,774, filed on Jun. 10, 2016.

(51) Int. Cl. G06T 7/579; H04N 5/232; H04N 13/02

(52) U.S. Cl. CPC G06T 7/579; H04N 13/0239; H04N 5/23287

(57) ABSTRACT

Depth determination includes obtaining a first image of a scene captured by a camera at a first position, obtaining a second image of the scene captured by the camera at a second position directed by an optical image stabilization (OIS) actuator, determining a virtual baseline between the camera at the first position and the second position, and determining a depth of the scene based on the first image, the second image, and the virtual baseline.

### BACKGROUND

This disclosure relates generally to the field of digital image capture and processing, and more particularly to the field of optical image stabilization for depth sensing.

The process of estimating the depth of a scene from two cameras is commonly referred to as stereoscopic vision and, when using multiple cameras, multi-view stereo. In practice, many multi-camera systems use disparity as a proxy for depth. (As used herein, disparity is taken to mean the difference in the projected location of a scene point in one image compared to that same point in another image captured by a different camera.) With a geometrically calibrated camera system, disparity can be mapped onto scene depth. The fundamental task for such multi-camera vision-based depth estimation systems then is to find matches, or correspondences, of points between images from two or more cameras. Using geometric calibration, the correspondences of a point in a reference image (A) can be shown to lie along a certain line, curve or path in another image (B).

Difficulties in determining depth may arise when disparity is not easily calculated. For example, if a stereo camera system is not available, determining depth can be difficult in a single camera system.

### SUMMARY

In one embodiment, a method for depth determination is described. The method may include obtaining a first image of a scene captured by a camera at a first position, obtaining a second image of the scene captured by the camera at a second position based on a displacement of an optical image stabilization (OIS) actuator, determining a virtual baseline between the camera at the first position and the second position, and determining a depth of the scene based on the first image, the second image, and the virtual baseline.

In another embodiment, the various methods may be embodied in computer executable program code and stored in a non-transitory storage device. In yet another embodiment, the method may be implemented in an electronic device having image capture capabilities.

### BRIEF DESCRIPTION OF THE DRAWINGS

FIG. 1 shows, in block diagram form, a simplified image capture device according to one or more embodiments.

FIG. 2 shows, in block diagram form, an example a camera system with an optical image stabilization (OIS) processor, according to one or more embodiments.

FIG. 3 shows, in flowchart form, a depth determination method in accordance with one or more embodiments.

FIG. 4 shows, in flowchart form, an example method of depth determination, according to one or more embodiments.

FIG. 5 shows, in flow diagram form, an example method of depth determination using OIS, according to one or more embodiments.

FIG. 6 shows, in block diagram form, a simplified multifunctional device according to one or more embodiments.

### DETAILED DESCRIPTION

This disclosure pertains to systems, methods, and computer readable media for depth determination. In general, techniques are disclosed for utilizing a camera system equipped with optical image stabilization (OIS) technology to determine depth of a scene. In one or more embodiments, two or more images are captured consecutively by an image capture device utilizing OIS. The position of the camera is different when capturing the first and second image. In one or more embodiments the position may change by moving the lens, such that the optical path from the lens to the sensor is modified.

In one or more embodiments, the movement between the first position and the second position may be directed by the OIS system. Further, in one or more embodiments, the movement from the first position to the second position may include a movement intended to compensate for external movement of the camera device, such as if a user is holding the camera device in their hand, as well as an additional movement. According to one or more embodiments, at least three images may be captured such that the movement between the first and second position is along a first axis, and the movement between the second and third position is along a second axis. The three or more images and the virtual baselines between the camera at each position may be used to determine depth of a scene captured in the images.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

For purposes of this disclosure, the term “lens” refers to a lens assembly, which could include multiple lenses. In one or more embodiments, the lens may be moved to various positions to capture images at multiple depths and, as a result, multiple points of focus. Further in one or more embodiments, the lens may refer to any kind of lens, such as a telescopic lens or a wide angle lens. As such, the term lens can mean a single optical element or multiple elements configured into a stack or other arrangement. For purposes of this disclosure, the term “camera” refers to a single lens assembly along with the sensor element and other circuitry utilized to capture an image.

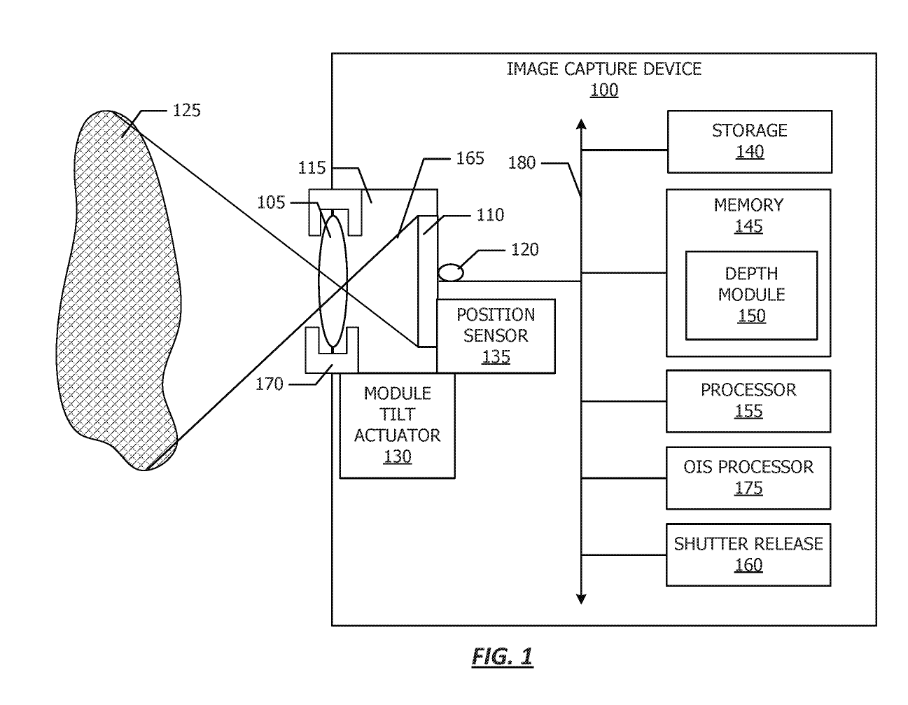

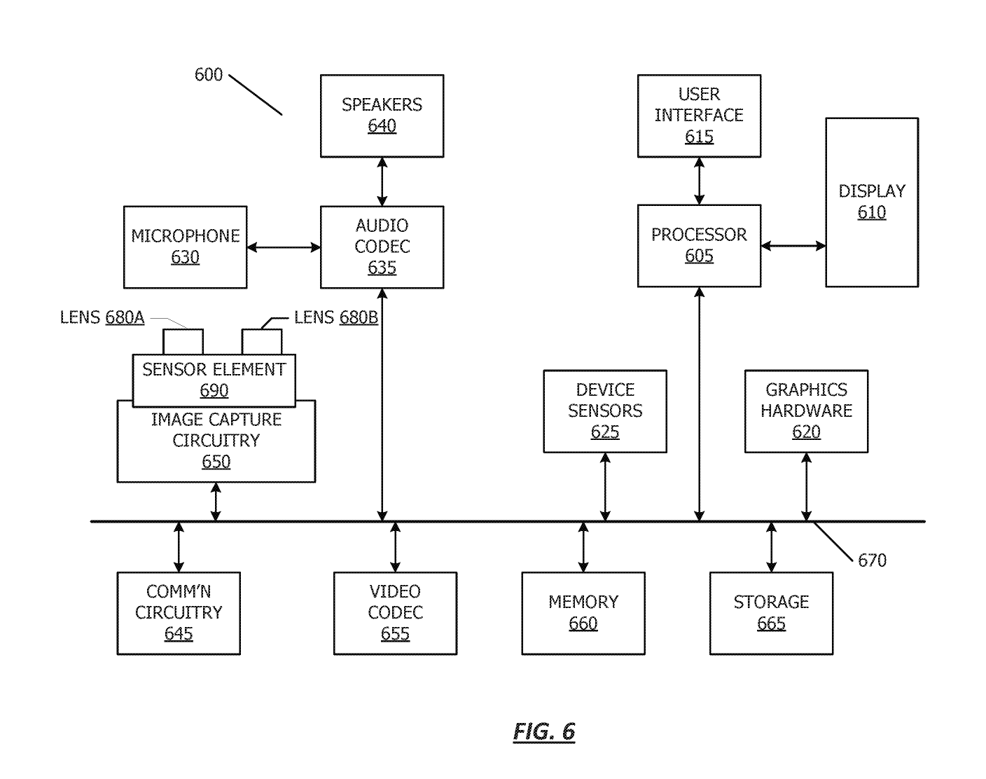

Referring to FIG. 1, a simplified block diagram of an image capture device 100 is depicted, in accordance with one or more embodiments of the disclosure. Image capture device 100 may be part of a mobile electronic device, such as a tablet computer, mobile phone, laptop computer, portable music/video player, or any other electronic device that includes a camera system. Further, in one or more embodiments, image capture device 100 may be part of any other multifunction device that includes a camera and supports OIS, such as those described below with respect to FIG. 6.

The image capturing device 100 includes, but is not limited to, a camera module 115, an actuator 130, a position sensor 135, a shutter release 160, storage 140, a memory 145 and a processor 155. The processor 155 may drive interaction between a plurality of the components comprising device 100. The processor 155 may be any suitably programmed processor within device 100. In one or more embodiments, the image capture device 100 may include a separate optical image stabilization (OIS) processor 175 that may provide OIS functionality. The OIS processor 175 may direct the movement of camera components to different positions in order to modify an optical path 165 between the lens 105 and the sensor 110.

In some embodiments, the processor 155 may be a primary processor such as a microprocessor or central processing unit (not shown). The processor 155 may communicate with the other illustrated components across a bus 180. The bus 180 can be any subsystem adapted to transfer data within the device 100. The bus 180 can be a plurality of computer buses and include additional circuitry to transfer data and generally facilitate inter-component communication (e.g., a switch).

Turning to the camera module 115, the camera module 115 incorporates many of the components utilized to capture an image, such as a lens 105 and an image sensor 110. The focal length of the camera module may be fixed. In some embodiments, the back focal length between lens 105 and image sensor 110 is less than four (4) millimeters (mm). Although the back focal length can be one (1) mm or less. The back focal length may be dictated by the z-height of the camera module 115. An infrared (IR) filter (not shown) may be included. In some embodiments, the camera module 115 features a wide field of view, such as in the range of 84° and 64°. Thus, the lens 105 may also be a wide-angle lens. However, the lens 105 may offer different fields of view in embodiments wherein the lens is a normal lens or an ultra-wide angle lens. The lens 105 may also feature a relatively low f-number, such as f/4 or lower.

The image sensor 110 of the camera module 115 can be, for example, a charge-coupled device (CCD) or complementary metal-oxide-semiconductor (CMOS) sensor. The image sensor 110 collects electrical signals during a capture period as a representation of the light traveling to image sensor 110 along an optical path 165 so that a scene 125 can be captured as an image. The scene 125 may be captured as one or more point sources. In some embodiments, the image sensor 110 may be coupled to an analog front end (not shown) to process the electrical signals. Image sensor 110 may employ a color filter array (CFA) so that each pixel sensor (not shown) of the image sensor 110 captures different color data. In some embodiments, the CFA is a Bayer CFA, which contains one blue sensor, one red sensor and two green sensors for every four pixel sensors.

The image sensor 110 may be operable to capture several images in succession over several successive capture periods. In one or more embodiments, the capture periods may be in rapid succession. Successive images may capture light reaching image sensor 110 across optical paths that vary from the optical path 165. The successive images may also be captured as multiple frames of a scene (e.g., video). Therefore, each image may offer unique pixel array data because light will have traveled a different optical path in reaching image sensor 110. Thus, image sensor 110 may capture a plurality of datasets, each dataset comprising different pixel array data of the same scene 125.

A shutter release 160 can effect a capture period of the image sensor 110. The shutter release 160 can be a component activated by a user, such as a tactile button provided on the housing of the image capturing device 100. Alternatively or in addition to a tactile input, the shutter release 160 may be presented to the user through an interface such as a touch input of the display screen (not shown), as is common in cellular telephones, mobile media devices, and tablet computers. The shutter release 160 can be triggered through other means as well, such as by a timer or other triggering event. A single trigger of the shutter release 160 may result in a plurality of capture periods, e.g. actuation of the shutter release 160 only once may result in the image sensor 110 capturing a plurality of separate images.

In one or more embodiments, coupled to the camera module 115 are the module tilt actuator 130 and the position sensor 135. The position sensor 135 can be a Hall-effect position sensor (and may additionally include one or more magnets (not shown)), a strain position sensor, a capacitance-type position sensor, or any other suitable position sensor. The position sensor 135 may be coupled to the camera module, and may be included therein, to provide the pitch and yaw of the camera module 115. Accordingly, the pointing angle (e.g., tilt) of the camera module 115 can be accurately determined. The pointing angle may influence the optical path to the image sensor 110. In some embodiments, position sensor 135 comprises a plurality of sensors, e.g. two or more Hall elements.

In one or more embodiments, the module tilt actuator 130 may adjust the pointing angle (e.g., tilt) of the camera module 115 about a pivot point 120, which can be a bearing or other suitable component. For purposes of this description, the various actuators may also be referred to as optical image stabilization (OIS) actuators. The module tilt actuator 130 may be a voice coil motor (VCM), a piezoelectric device, or other actuator suitable for implementation within an image capturing device. In some embodiments, the module tilt actuator 130 is operable to adjust the pointing angle of the camera module 115 from the optical path 165 to a shifted optical path (not shown) with such controlled precision that the image sensor 110 may capture an image through the shifted optical path that is offset from a first image captured along the optical path 165 by a known sub-pixel amount. To control the shift, a voltage may be applied to the module tilt actuator 130. To realize this level of precision, the actuator 130 may be sufficiently linear and free from hysteresis. In some embodiments, the module tilt actuator 130 is comprised of multiple components, e.g. one actuator to shift the pitch and another actuator to shift the yaw.

To accomplish such sub-pixel shifts of the optical path, the module tilt actuator 130 may be communicatively coupled to an optical image stabilization (OIS) processor 175. The OIS processor 175 may be implemented in firmware, software or hardware (e.g., as an application-specific integrated circuit). In normal conditions, the OIS processor 175 may stabilize the image projected onto the image sensor 110 before the sensor converts the image into digital information (e.g., by varying the optical path to the image sensor in response to detected movement of the device 100, such as involuntary shaking by the user holding the device 100). The OIS processor 175 may be operable to control the time and interval of image capturing by the image sensor 110. In addition to stabilizing an image projected onto the image sensor 110, the OIS processor 175 can be operable to displace one or more components (e.g., the camera module 115) affecting the optical path 165 by commanding a shift. The shift may be known or predetermined. In some embodiments, the OIS processor 175 is operable to apply a voltage (not shown) to the module tilt actuator 130 so that the module tilt actuator 130 may shift the optical path by adjusting the pointing angle (e.g., the tilt) of the camera module 115 (e.g., about pivot 120). An applied voltage may be a centivolt or a millivolt value so that the optical path 165 to the image sensor 110 is shifted. In one or more embodiments, the sensor 110 may be shifted by an accurate sub-pixel amount. The applied voltage may be known and/or predetermined so that the shift to the optical path is known or predetermined. The OIS processor 175 may also receive signals from the position sensor 135 that accurately indicate the pointing angle (e.g., tilt) of the camera module 115 influencing the optical path 165.

The OIS processor 175 may command one or more shifts of the optical path 165 by adjusting the pointing angle of the camera module 115. The OIS processor 175 may command these shifts between rapidly successive captures of images resulting from a single activation of shutter release 160. The algorithm utilized for OIS may have predetermined values for each shift and/or may be responsive to data received from the module tilt actuator 130, the position sensor 135, or an inertial sensor (not shown).

In one or more embodiments, the image capture device 100 may additionally, or alternatively, include additional components that allow for movement of the lens 105. Specifically, the camera module 115 may include a lens actuator 170 coupled to the lens 105. The lens actuator 170 may shift the optical path 165 from the lens 105 to the sensor 110 by moving the lens 105, according to one or more embodiments. The lens actuator 170 may be activated by the OIS processor 175. Activating the lens actuator 170 may change the pointing angle influencing the optical path 165 by translating the lens 105. The lens actuator 175 may produce sufficiently linear translations of the lens 105 across a horizon plane (e.g., x axis) and the picture plane (e.g., y axis).

In some embodiments, the offset between two images captured through two different optical paths is known with sub-pixel accuracy because the commanded shift is known and controlled (e.g., the shift may be predetermined or calculated from one or more stored sub-pixel coefficients). Said another way, a virtual baseline between the first camera position and the second camera position may be determined based on the known commanded shift. In one or more embodiments, the shift may be directed in order to overcome some external force on the image capture device 100, or some movement of the image capture device 100. In one or more embodiments, the shift may include additional shift not directed to compensation for external forces on the image capture device 100. The additional shift may also be known with precision, as it may be directed by the OIS processor 175. An image captured with the first optical path at the first camera position, and the second optical path at the second camera position, may be compared to determine a depth of the scene 125.

The image capturing device 100 includes storage 140 that may be operable to store one or more images (e.g., optical samples) captured by image sensor 110. Storage 140 may be volatile memory, such as static random access memory (SRAM) and/or dynamic random access memory (DRAM). Alternatively or in addition to volatile memory, storage 140 may include non-volatile memory, such as read-only memory (ROM), flash memory, and the like. Furthermore, storage 140 may include removable storage devices, such as secure digital (SD) cards. Storage 140 may additionally provide storage of computer readable instructions, data structures, application modules, and other data for image capturing device 100. Accordingly, while storage 140 is illustrated as a single component, storage 140 may comprise a plurality of separate components (e.g., RAM, flash, removable storage, etc.).

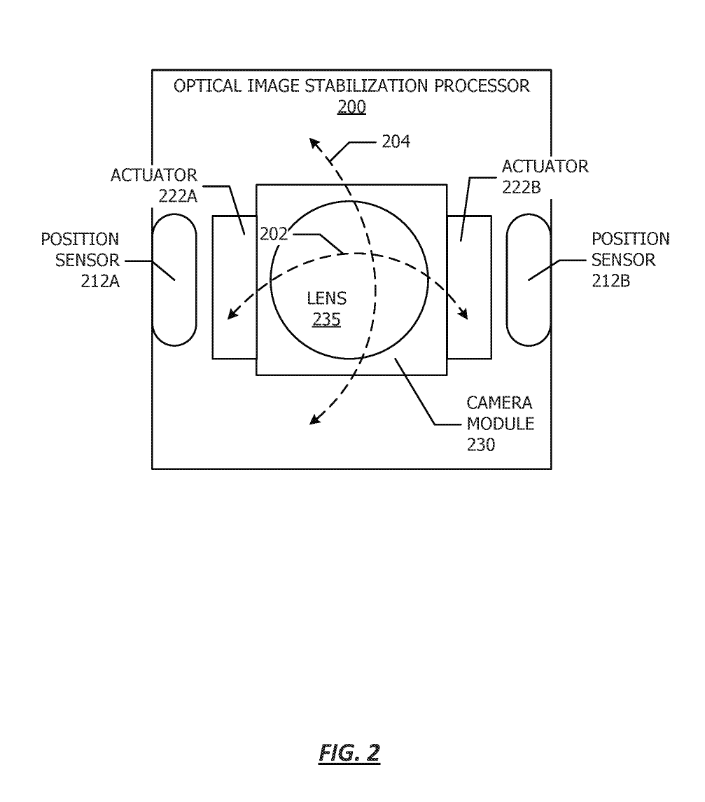

FIG. 2 shows a block diagram depicting a top view of a camera module 230 with an optical image stabilization processor 200. The components illustrated at FIG. 2 may be analogous to those presented in FIG. 1: a camera module 230 with a lens 235 may be the camera module 115 with the lens 105; position sensors 212A and 212B may be the position sensor 135; actuators 222A and 222B may be the module tilt actuator 130; and optical image stabilization (OIS) processor 200 may be OIS processor 175. The OIS processor 200 is operable to receive input from the position sensors 212 that indicate the position (e.g., pointing angle) of the camera module 230 influencing the optical path to the image sensor.

The OIS processor 200 is operable to command a shift of the camera module 230 along the horizon plane, the picture plane or both simultaneously. The OIS processor 200 may command this shift by activating the actuators 222 (e.g., by applying a voltage thereto). In response, the actuators 222 adjust the pointing angle of the camera module 230. The pointing angle of the camera module 230 may be adjusted about the horizon plane 202 and the picture plane 204. Consequently, the optical path to the image sensor is shifted. The shift may be calculated to sub-pixel accuracy. The actuators 222 may cause this shift by pivoting camera module 230 about a pivot point, such as a bearing. A commanded shift may be approximately linear, even where the camera module 230 is tilted about a pivot point. Thus, the tilt may only appreciably shift the optical path linearly (e.g., the tilt may be less than a degree, less than an arcminute or even less than an arcsecond). Other components may be employed to adjust the pointing angle, e.g., the actuators 222 may adjust the pointing angle of the camera module 230 using one or more springs.

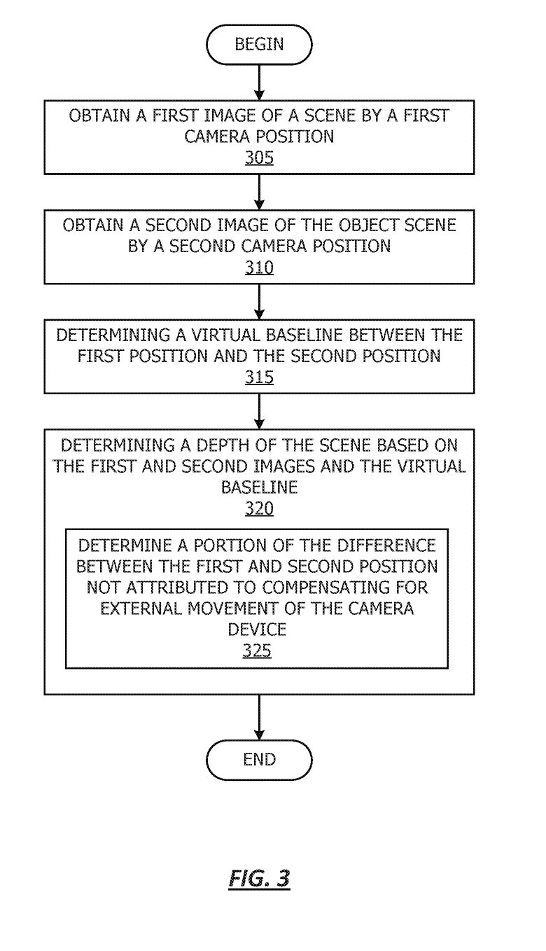

FIG. 3 shows, in flowchart form, a depth determination method in accordance with one or more embodiments. The operation begins at 305, and a first image of a scene is obtained by a camera at a first camera position. In one or more embodiments, the initial image is captured without any displacement due to OIS. The first camera position may indicate a first alignment, or a first optical path, from the lens to the sensor in the camera module.

The operation continues at 310 and a second image is captured using the camera. The first and second images may be captured sequentially, and rapidly. In one or more embodiments, the second image is captured at a different camera position that is directed by the OIS processor. For example the OIS processor may direct a shift by the lens such that the optical path is altered. In one or more embodiments, the OIS processor may direct the lens to a second position that involves additional movement than that which is used for compensating for device motion.

At 315, a virtual baseline between the first position and the second position may be determined. That is, in one or more embodiments, a determination can be made regarding a difference in location of the optical center of the camera between the first image and the second image. If the sensor has moved, a determination may be made regarding the difference in position of the lens with respect to the sensor between the first image and the second image. A change in the optical center due to the movement may be indicated by the camera's intrinsic matrix. The camera's extrinsic matrix may also be modified to include the distance between the position of the camera at the first image and the position of the camera at the second image.

At 320, a depth of the scene may be determined based on the first and second images and the determined virtual baseline. Depth may be determined in any number of ways. For example, standard stereo depth estimation techniques may be applied between the two frames. The modified intrinsic and extrinsic matrices, as described above, may be used with stereo depth estimation. In one or more embodiments, because the exact shift between the first and second camera position is known, disparity shifts will occur along the axis of the displacement. The disparity information may then be used to determine depth. In one or more embodiments, the depth may be determined by comparing the disparity of a feature point in the two images, after compensating for movement of the lens with respect to the sensor. In one or more embodiments, distortion differences in the two images may need to be addressed in order to determine depth. Determining the depth of a scene may include, at 325, determining a portion of the difference between the first and second camera position that is not attributable to compensating for external movement of the camera device.

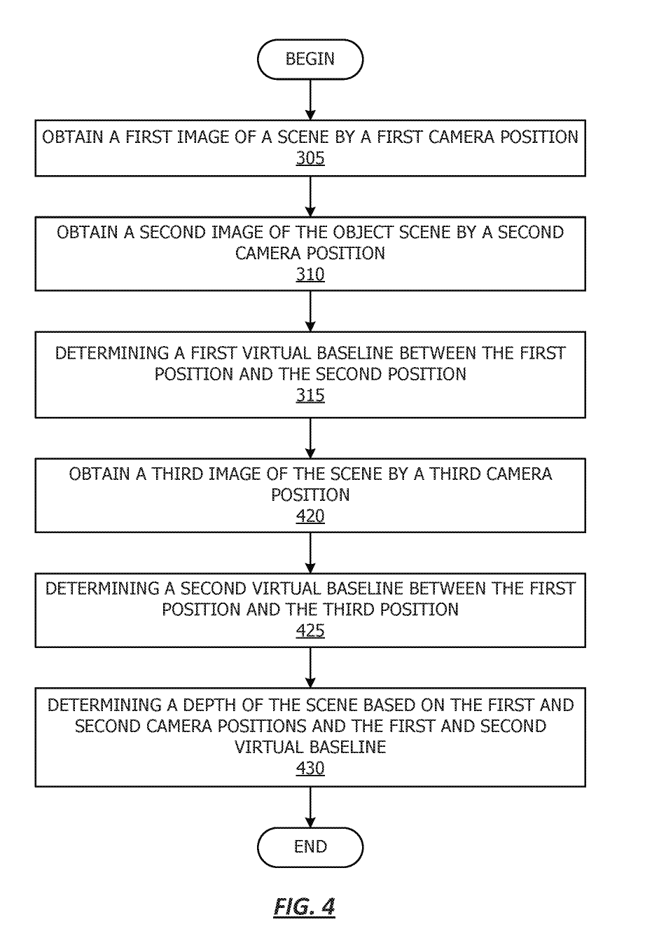

FIG. 4 shows, in flowchart form, an example method of depth determination, according to one or more embodiments. The flowchart includes many of the same features depicted in FIG. 3. Specifically, FIG. 4 includes steps 305-315, where the first and second images are obtained and a virtual baseline between the first and second images is determined.

The flowchart differs from FIG. 3 beginning at block 420, where a third image of the scene is captured at a third camera position. In one or more embodiments, the third image (captured at a third position) may be obtained by a different camera. For example, the first and second camera positions may refer to one camera of a stereo camera system, whereas the third image is captured by another camera of the stereo camera system.

The flowchart continues at block 425, at a second virtual baseline between the first position and the third position is determined. Alternatively, or additionally, a second virtual baseline between the second position and third position may be determined. In one or more embodiments, the first and second virtual baselines may lie along different axes.

The flow diagram continues at 430, and a depth of the scene is determined based on the first and second camera positions and the first and second virtual baselines. In one or more embodiment, the third position may also be used.

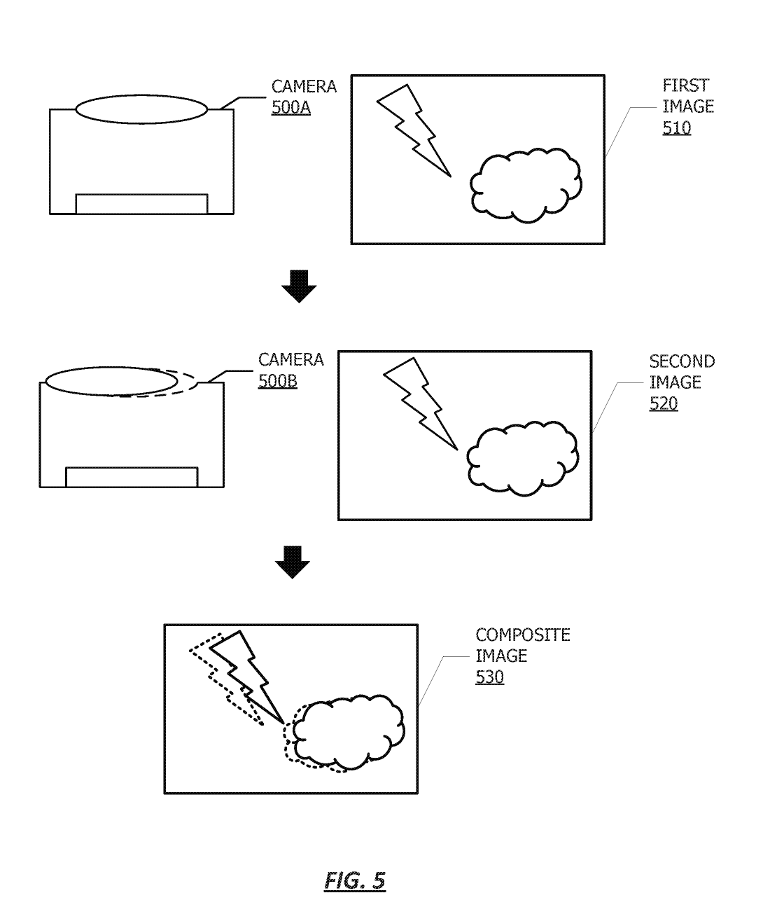

FIG. 5 shows, in flow diagram form, an example method of depth determination using OIS, according to one or more embodiments. The flow diagram begins with simplified camera module 500A which includes a lens and a sensor. The components of the camera module are in a first position. That is, there is a first optical path between the lens and the sensor. The camera at 500A captures a first image 510 of a scene.

Next, the camera captures an image 520 at a second position 500B. That is, the optical path between the lens and the sensor is modified. In one or more embodiments, the OIS processor directs the movement of the lens to modify the optical path. As described above, the two images may be captured rapidly and sequentially, and as a result of a single activation of a shutter release. The result is that the second image of the scene 520 is slightly different than the first 510.

Composite image 530 shows, for purposes of this example, what the two images look like when compared to each other (i.e., after registration). As shown, some features in the scene move more than others. Said another way, the disparity of the various feature points in the scene varies based on depth. In one or more embodiments, it may be necessary to compensate for the movement of the lens before comparing the two images. Further, depth may be determined by utilizing the disparity and a virtual baseline of the two pictures, or a known movement of the camera components as directed by an OIS processor.

In one or more embodiments, the movement from the first position to the second position may be very small, and the disparity may be calculated within a pixel.

In one or more embodiments, depth could also be determined based on illumination variation.

Referring now to FIG. 6, a simplified functional block diagram of illustrative multifunction device 600 is shown according to one embodiment. Multifunction electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system 100) video codec(s) 655 (e.g., in support of digital image capture unit 650), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images and single and multi-camera calibration as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen and/or a touch screen. Processor 605 may also, for example, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still and/or video images. Output from image capture circuitry 650 may be processed, at least in part, by video codec(s) 665 and/or processor 605 and/or graphics hardware 620, and/or a dedicated image processing unit or pipeline incorporated within circuitry 665. Images so captured may be stored in memory 660 and/or storage 655.

Sensor and camera circuitry 650 may capture still and video images that may be processed in accordance with this disclosure, at least in part, by video codec(s) 655 and/or processor 605 and/or graphics hardware 620, and/or a dedicated image processing unit incorporated within circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random access memory (RAM). Storage 665 may store media (e.g., audio, image and video files), computer program instructions or software, preference information, device profile information, and any other suitable data. Storage 665 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or code organized into one or more modules and written in any desired computer programming language. When executed by, for example, processor 605 such computer program code may implement one or more of the methods described herein.

In addition to the features described above, other information may be utilized for determining depth in the scene. For example, multiple images captured in succession at different camera positions may provide different information about depth. Further, when the above techniques are utilized in a stereo camera system, a determined depth based on the three images may provide enough information to determine a baseline in the stereo camera. Determining the baseline in a stereo camera system may be used, for example, to recalibrate the camera.

The scope of the disclosed subject matter therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method for depth determination, comprising:
obtaining a first image of a scene captured by a camera at a first position;
obtaining a second image of the scene captured by the camera at a second position, the second position determined by an optical image stabilization (OIS) actuator;
determining a virtual baseline based on the first position and the second position; and
determining a depth of the scene based on the first image, the second image, and the virtual baseline.

2. The method of claim 1, wherein the second position is based on a displacement comprising a first portion and a second portion, the first portion corresponding to a displacement to compensate for an external motion of the camera and the second portion an additional known displacement.

3. The method of claim 2, wherein determining the depth of the scene comprises:
determining a displacement of the camera with respect to the sensor associated with the camera from the first position to the second position; and
determining the depth based on the second portion of the displacement of the camera with respect to the sensor.

4. The method of claim 1, wherein determining a virtual baseline based on the first position and the second position comprises obtaining a displacement of a lens of the camera as directed by the OIS actuator.

5. The method of claim 1, further comprising:
obtaining a third image of the scene captured by the camera at a third position, the third position determined by the OIS actuator, wherein the first position and the second position are along a first axis, and the second position and the third position are along a second axis; and
determining the depth of the scene is further based on the first image, the second image, the third image, the first position, the second position, and the third position.

6. The method of claim 1, further comprising:
obtaining a third image of the scene captured by a second camera, wherein the camera and the second camera are part of a stereo camera system,
wherein an axis that includes the camera at the first position and the second camera is different than an axis that includes the camera at the second position and the second camera, and
wherein the depth of the scene is further determined based on the first image, the second image, the third image, the first position, and the second position.

7. The method of claim 1, wherein determining a depth of the scene is further based on a sub-pixel disparity determination.

8. A computer readable medium comprising computer readable code executable by a processor to:
obtain a first image of a scene captured by a camera at a first position;
obtain a second image of the scene captured by the camera at a second position, the second position determined by an optical image stabilization (OIS) actuator;
determine a virtual baseline based on the first position and the second position; and
determine a depth of the scene based on the first image, the second image, and the virtual baseline.

9. The computer readable medium of claim 8, wherein the second position is based on a displacement comprising a first portion and a second portion, the first portion corresponding to a displacement to compensate for an external motion of the camera and the second portion an additional known displacement.

10. The computer readable medium of claim 9, the computer readable code to determine the depth of the scene comprises computer readable code to:
determine a displacement of the camera with respect to the sensor associated with the camera from the first position to the second position; and
determine the depth based on the second portion of the displacement of the camera with respect to the sensor.

11. The computer readable medium of claim 8, wherein determining a virtual baseline based on the first position and the second position comprises obtaining a displacement of a lens of the camera as directed by the OIS actuator.

12. The computer readable medium of claim 8, further comprising computer readable code executable by one or more processors to:
obtain a third image of the scene captured by the camera at a third position, the third position determined by the OIS actuator, wherein the first position and the second position are along a first axis, and the second position and the third position are along a second axis; and
determine the depth of the scene is further based on the first image, the second image, the third image, the first position, the second position, and the third position.

13. The computer readable medium of claim 8, further comprising computer readable code executable by one or more processors to:
obtaining a third image of the scene captured by a second camera, wherein the camera and the second camera are part of a stereo camera system,
wherein an axis that includes the camera at the first position and the second camera is different than an axis that includes the camera at the second position and the second camera, and
wherein the depth of the scene is further determined based on the first image, the second image, the third image, the first position, and the second position.

14. The computer readable medium of claim 8, wherein determining a depth of the scene is further based on a sub-pixel disparity determination.

15. A system for depth determination, comprising:
a camera;
one or more processors; and
a memory coupled to the one or more processors and comprising computer code executable by the one or more processors to:
obtain a first image of a scene captured by a camera at a first position;
obtain a second image of the scene captured by the camera at a second position directed by an optical image stabilization (OIS) actuator;
determine a virtual baseline based on the first position and the second position; and
determine a depth of the scene based on the first image, the second image, and the virtual baseline.

16. The system of claim 15, wherein the second position is based on a displacement comprising a first portion and a second portion, the first portion corresponding to a displacement to compensate for an external motion of the camera and the second portion an additional known displacement.

17. The system of claim 16, the computer readable code to determine the depth of the scene comprises computer readable code to:
determine a displacement of the camera with respect to the sensor associated with the camera from the first position to the second position; and
determine the depth based on the second portion of the displacement of the camera with respect to the sensor.

19. The system of claim 15, further comprising computer readable code executable by one or more processors to:
obtain a third image of the scene captured by the camera at a third displacement of the OIS actuator, wherein:
the first displacement and the second displacement are along a first axis, and the second displacement and the third displacement are along a second axis, and
wherein the depth of the scene is further determined based on the first image, the second image, the third image, the first displacement, the second displacement, and the third displacement.

20. The system of claim 15, further comprising computer readable code executable by one or more processors to:
obtaining a third image of the scene captured by a second camera, wherein the camera and the second camera are part of a stereo camera system,
wherein an axis that includes the camera at the first position and the second camera is different than an axis that includes the camera at the second position and the second camera, and
wherein the depth of the scene is further determined based on the first image, the second image, the third image, the first position, and the second position.
